(19) United States
(12) Patent Application Publication
(10) Pub. No.: US 2016/0130160 A1
(43) Pub. Date: May 12, 2016

(54) PROCESS FOR REDUCING THE TOTAL ORGANIC CARBON IN WASTEWATER

(71) Applicants: BASF SE, Ludwigshafen (DE); DOW GLOBAL TECHNOLOGIES LLC, Midland, MI (US)

(72) Inventors: Holger BAER, Fredenbeck (DE); Harlan R. GOLTZ, Midland, MI (US); Joerg LINDNER, Himmelpforten (DE); Astrid LENZ, Alfter (DE)

(73) Assignees: BASF SE, Ludwigshafen (DE); Dow Global Technologies LLC, Midland, MI (US)

(21) Appl. No.: 14/896,097

(22) PCT Filed: Jun. 4, 2014
(86) PCT No.: PCT/EP2014/061595

§ 371 Date: Dec. 4, 2015

(30) Foreign Application Priority Data
Jun. 4, 2013 (EP) 13170484.3

(51) Int. Cl. C02F 1/44; C02F 3/00; C02F 1/28

(52) U.S. Cl. CPC C02F 1/441; C02F 1/283; C02F 1/285; C02F 3/00; C02F 2103/36

(57) ABSTRACT

The present invention relates to a process for reducing the total organic carbon (TOC) in an aqueous mixture M1 obtained as wastewater from a process for the preparation of an olefin oxide, the process for reducing the TOC comprising: (a) contacting the mixture M1 which contains at least one oxygenate having from 1 to 16 carbon atoms with an adsorbing agent and adsorbing at least a portion of an oxygenate at the adsorbing agent; (b) separating an aqueous mixture M2 from the adsorbing agent, the mixture M2 being depleted of the oxygenate adsorbed in (a); and (c) separating an oxygenate from the mixture M2 obtained in (b) by subjecting the mixture M2 to reverse osmosis in at least one reverse osmosis unit containing a reverse osmosis membrane obtaining an aqueous mixture M3 being depleted of this oxygenate.

The present invention relates to a process for reducing the total organic carbon (TOC) in wastewater obtained from a process for the preparation of an olefin oxide.

Olefin oxides belong to the most important basic chemicals. The annual production of olefin oxides such as ethylene oxide or propylene oxide amounts in each case to almost one million tons per year. Olefin oxides are fore example widely used as starting compounds in the synthesis of ethylene glycol, polyethylene glycols, propylene glycol, polyether polyols, which in turn are used as starting materials the production of polymers such as polyesters or polyurethanes.

Several production routes for the preparation of an olefin oxide starting from an olefin have been developed to meet the high demand for olefin oxides. For example, a preferred route for the production of an olefin oxide which has already been implemented successfully at large scale is the epoxidation of the olefin with an aqueous hydrogen peroxide solution in the presence of an organic solvent and a heterogeneous catalyst.

The initially formed reaction mixture in the catalytic epoxidation of an olefin with hydrogen peroxide generally contains an organic solvent, water, the olefin oxide, optionally unreacted olefin, and oxygenate side- or by-products. Examples of oxygenate side- or by-products, in particular in case propene is reacted with an aqueous hydrogen peroxide solution obtaining propylene oxide, may include alkoxyalcohols, glycols, alpha-hydroperoxyalcohols, formaldehyde, acetaldehyde, hydroxyacetone, and the like.

In large scale production, the initially formed reaction mixture comprising the olefin oxide is usually subjected to a downstream work-up process comprising several separation and other workup stages. The unreacted olefin and the organic solvent employed require an effective recovery in sufficient purity for their re-use. Further, considering in particular the large scale production of olefin oxides, many side- or by-products may occur in sufficiently large amounts so that they can be used, after a suitable effective separation, as chemical compounds for further use.

The water present in the initially formed reaction mixture originates either from the aqueous hydrogen peroxide solution or is one of the stoichiometric products of the epoxidation reaction. This amounts to several million tons of industrial wastewater per year obtained in the olefin oxide production. This wastewater requires thorough treatment for removing contaminants prior to its re-use or a release into the environment.

Among the publications covering the preparation of olefin oxides, only a few are concerned with the treatment of the wastewater and recovering side- or by-products from the reaction mixture.

WO-A 2004/000773 refers to a process of separating 1-methoxy-2-propanol and 2-methoxy-1-propanol from aqueous compositions, comprising dewatering of the aqueous composition comprising 1-methoxy-2-propanol and 2-methoxy-1-propanol to a concentration of 1-methoxy-2-propanol and 2-methoxy-1-propanol of at least 90 weight-% in total and isolation of 1-methoxy-2-propanol, 2-methoxy-1-propanol or mixtures thereof by means of distillation. According to WO-A 2004/000773, dewatering of the aqueous composition can be achieved by a membrane separation. Thereby the aqueous composition comprising 2-methoxy-1-propanol and 1-methoxy-2-propanol is contacted with a semipermeable, hydrophilic membrane in a suitable apparatus either in liquid phase as pervaporation step or in the gaseous phase as vapor permeation step. Across the semipermeable membrane a pressure difference is established. The permeate will substantially contain water and only a minor amount of 1-methoxy-2-propanol and 2-methoxy-1-propanol. According to WO-A 2004/000773, the major amount of 1-methoxy-2-propanol and 2-methoxy-1-propanol fed to the apparatus will not pass the membrane and can be collected as a retentate with a reduced water content.

U.S. Pat. No. 5,599,955 describes an integrated process for the production of propylene oxide from a feedstream such as synthesis gas. In the process, propylene oxide is produced from a feedstream comprising hydrogen and a carbon oxide. The propylene stream is epoxidized with hydrogen peroxide which has been produced from hydrogen separated from a portion of the feedstream. The spent water stream produced by the epoxidation reaction is treated to remove heavy components and returned to the hydrogen peroxide production zone. The recycling of spent water from the epoxidation reaction zone and the removal of heavy compounds eliminates a low value water stream, and the recovery of heavy hydrocarbons therefrom produces a valuable secondary product. The spent water stream is passed to a separation zone such as an evaporator, a distillation zone or a sorption zone.

US-A 2002/010378 discloses a composite process for subjecting ethylene to catalytic gas phase oxidation thereby obtaining ethylene oxide and causing this ethylene oxide to react with water thereby obtaining ethylene glycol. In the production of ethylene glycol by the supply of the aqueous ethylene glycol solution to a concentrating treatment at the multi-effect evaporator, the method contemplated by U.S. Pat. No. 2002/010378 for the production of ethylene glycol comprises utilizing as the source of heating at least one specific step the steam generated in the multieffect evaporator.

U.S. Pat. No. 6,288,287 discloses a process for preparing a glycerol from a crude glycerol composition comprising a glycerol, a diol and water, comprising feeding the crude glycerol composition to a preparation apparatus comprising two or more, serially connected flash towers and a distillation tower connected to a final flash tower, wherein a bottom fraction of each flash tower is fed to a subsequent flash tower.

U.S. Pat. No. 5,269,933 and EP-A 0 532 905 disclose a method for the separation of a mixture of an organic fluid and water, such as carboxylic acids including acetic acid and propionic acid, aromatic amines including aniline, phenol, and glycerine. The method is a combination of a distillation, a water-selective pervaporation and a reverse osmosis and is particularly suitable for the separation of glycol and water. The process according to U.S. Pat. No. 5,269,933 comprises distilling the mixture, performing a water-selective pervaporation to a bottom product obtained from the distillation step obtaining a residue and a permeate, applying a reverse osmosis step to at least the distillate obtaining a residue and a permeate, and feeding the residue obtained from the reverse osmosis to the distillation step, such that segregated organic fluid is present as residue from the water-selective pervaporation, and segregated water is present as the permeate from the water-selective pervaporation step as well as the permeate from the reverse osmosis step.

According to EP-A 0 324 915, valuable materials can be separated from aqueous solutions by extraction and/or distillation; the solution can be concentrated by reverse osmosis in an upstream step. The valuable materials are separated solely by distillation following concentration of the solution by optionally multi-stage reverse osmosis. According to the process disclosed in EP-A 0 324 915 A, the valuable material leaves the distillation column with the bottom stream or the top stream.

U.S. Pat. No. 6,712,882 discloses a process for treating wastewater from an industrial process for producing propylene oxide, which process involves the steps of (a) subjecting the wastewater to a multi-effect evaporation treatment resulting in a vapor top fraction and a liquid bottom fraction containing the non-volatile contaminants; and (b) condensing at least part of the vaporous top fraction into a liquid stream which is subject to a stripping treatment resulting in an overhead stream containing volatile waste organic material and purified water as the liquid bottom stream.

Following the production of an olefin oxide and its subsequent downstream processing, the suitably separated wastewater will typically comprise traces of certain oxygenates. One of the strategies to remove the oxygenates in order to comply with the purity standards in case of a reuse or with environmental regulations is subjecting the wastewater to a reverse osmosis treatment. Such a wastewater treatment is described in WO-A 2007/074066 disclosing a process for separating at least one propylene glycol from a mixture (M) comprising water and said propylene glycol, said process comprising (I) evaporating the mixture in at least two evaporation and/or distillation stages at decreasing operating pressures of the evaporators and/or distillation columns obtaining mixture (M′) and mixture (M″); and (II) separating the mixture (M′) obtained in (I) in at least one further distillation step, obtaining a mixture (M-I) comprising at least 70 weight-% of water and a mixture (M-II) comprising less than 30 weight-% of water.

However, in particular when feeding the wastewater in high-throughput to the reverse osmosis unit, a rapid deactivation of the reverse osmosis membrane can be observed in certain cases, necessitating a frequent and costly regeneration and/or replacement of the reverse osmosis membrane.

Thus, it was an object of the present invention to provide an advantageous process for the treatment of the wastewater which is obtained from a process for the preparation of an olefin oxide, which in particular allows avoiding the problems observed with regard to the reverse osmosis membrane.

According to the present invention, it was surprisingly found that the deactivation of an reverse osmosis membrane used in the wastewater treatment of an aqueous mixture which was obtained from a process for the preparation of an olefin oxide, preferably propylene oxide, can be considerably delayed if upstream the reverse osmosis membrane, preferably directly upstream the reverse osmosis membrane, the aqueous mixture is subjected to an adsorbing stage where at least one organic oxygenate contained in the aqueous mixture is suitably adsorbed at an adsorbing agent.

Therefore, the present invention provides a process for reducing the total organic carbon (TOC) in an aqueous mixture M1 obtained as wastewater from a process for the preparation of an olefin oxide, the process for reducing the TOC comprising:
(a) contacting the mixture M1 which contains at least one oxygenate having from 1 to 16 carbon atoms with an adsorbing agent and adsorbing at least a portion of an oxygenate at the adsorbing agent;
(b) separating an aqueous mixture M2 from the adsorbing agent, the mixture M2 being depleted of the oxygenate adsorbed in (a);
(c) separating an oxygenate from the mixture M2 obtained in (b) by subjecting the mixture M2 to reverse osmosis in at least one reverse osmosis unit containing a reverse osmosis membrane obtaining an aqueous mixture M3 being depleted of this oxygenate.

By employing this upstream adsorption stage according to the present invention, the running time of a reverse osmosis unit could be significantly increased, and thus, the frequent and costly regeneration and/or replacement of the reverse osmosis membrane could be avoided. Therefore, the overall process of the treatment of the wastewater obtained from a process for the preparation of an olefin oxide and the wastewater treatment could be increased with respect to its ecological and economic characteristics which are of great importance in particular regarding large-scale process such as the production of olefin oxides, in particular propylene oxide.

### Step (a)

Step (a) of the process of the present invention comprises contacting a mixture M1 obtained as wastewater from a process for the preparation of an olefin oxide, the mixture M1 containing at least one oxygenate having from 1 to 16 carbon atoms, with an adsorbing agent and adsorbing at least a portion of an oxygenate at the adsorbing agent for reducing the total organic carbon (TOC) in the mixture M1.

The term “TOC” as used in the present invention is the amount of carbon bound in an organic compound present in aqueous systems. The TOC determination is usually a two step process, comprising acidifying a sample and flushing with nitrogen or helium for removing inorganic carbon in the form of CO₂, followed by complete oxidation of the remaining organic carbon sources also to CO₂. The CO₂ originating from organic carbon sources may be detected via a conductivity or infrared measurement. Complete oxidation of the organic compounds is achieved by combustion, photo-oxidation or persulfate oxidation. Preferably, the TOC according to the present invention is to be understood as being determined according to DIN EN 1484.

Generally, the water content of the mixture M1 is not subject to specific restrictions. Preferably, the aqueous mixture M1 contains water in an amount of at least 95 weight-%, more preferably at least 98 weight-%, more preferably at least 99 weight-%, more preferably at least 99.4 weight-% relative to the total weight of the aqueous mixture M1.

Generally, the content of the mixture M1 with regard to the at least one oxygenate is not subject to specific restrictions. Preferably, the aqueous mixture M1 contains the at least one oxygenate in an amount of at most 1 weight-%, more preferably at most 0.5 weight-%, more preferably at most 0.3 weight-%, more preferably at most 0.2 weight-%, relative to the total weight of the aqueous mixture M1. More preferably, the aqueous mixture M1 contains the at least one oxygenate in an amount in the range of from 0.01 to 1 weight-%, preferably from 0.01 to 0.5 weight-%, more preferably from 0.01 to 0.3 weight-%, more preferably from 0.01 to 0.2 weight-%.

The term “oxygenate” as used according to the present invention is defined as a chemical compound containing oxygen as part of its chemical structure. The at least one oxygenate contained in the mixture M1 preferably has from 1 to 16 carbon atoms, more preferably from 1 to 12 carbon atoms, more preferably from 1 to 10 carbon atoms. Further preferred ranges may include 2 to 10 carbon atoms or from 4 to 12 carbon atoms or from 4 to 16 carbon atoms or from 5 to 16 carbon atoms. Preferably, the at least one oxygenate is selected from the group consisting of linear or branched, saturated or unsaturated, substituted or unsubstituted aliphatic C₁₋₁₆ oxygenates, saturated or unsaturated, substituted or unsubstituted cycloaliphatic C₄₋₁₆ oxygenates, substituted or unsubstituted, substituted or unsubstituted C₅-C₁₆ aralkyl oxygenates, substituted or unsubstituted C₅-C₁₆ alkaryl oxygenates, and combinations of two or more thereof.

Preferably, the oxygenate contained in mixture M1 is selected from the group consisting of alcohols, ethers, aldehydes, ketones, and combinations of two or more thereof.

More preferably, the at least one oxygenate contained in mixture M1 is selected from the group consisting of methanol, ethanol, propanol, methoxypropanol (MOP), monopropylene glycol (MPG), dipropylene glycol (DPG), tripropylene glycol (TPG), dipropylene glycol methyl ether (DPGME), tripropylene glycol monomethyl ether (TPGME), acetaldehyde, hydroxyacetone, anthraquinone, anthraquinone derivatives, and mixtures of two or more thereof. Anthraquinone derivatives are preferably selected from the group consisting of C₂-C₅ alkyl anthraquinones, more preferably selected from the group consisting of 2-ethyl anthraquinone, tetrahydro-2-ethyl anthraquinone, 2-isopropylanthraquinone, 2-sec-butylanthraquinone, 2-t-butylanthraquinone, 2-sec-amylanthraquinone, 1,3-dimethylanthraquinone, 2,3-dimethylanthraquinone, 1,4- dimethyl-anthraquinone, 2,7-dimethylanthraquinone, amylanthraquinone, tetrahydroamylanthraquinone, and combinations of two or more thereof.

One source of the anthraquinone and/or the anthraquinone derivatives is hydrogen peroxide which is preferably used as epoxidation agent for the preparation of the olefin oxide from the respective olefin, preferably for the preparation of propylene oxide from propene, optionally admixed with propane.

Hydrogen peroxide is produced almost exclusively via the anthraquinone process. This process is based on the catalytic hydrogenation of an anthraquinone and/or a derivative thereof to form the corresponding anthrahydroquinone compound. The anthrahydroquinone compound is further reacted with oxygen to form hydrogen peroxide which is subsequently extracted with water. The cycle is restarted by rehydrogenation of the anthraquinone compound which has been formed again in the oxidation. It is conceivable that in the extraction of hydrogen peroxide traces of the anthraquinone compound may pass over into the water phase. According to the present invention, it is preferred to employ a hydrogen peroxide which is obtained as crude hydrogen peroxide solution by extraction of a mixture which results from a process known as anthraquinone process by means of which virtually the entire world production of hydrogen peroxide is produced. Reference is made to Ullmann's Encyclopedia of Industrial Chemistry, 5th edition, volume A 13 (1989) pages 443-466, wherein a solution of an anthraquinone is used containing an alkyl group preferably having of from 2 to 10 carbon atoms, more preferably at least 5 carbon atoms such as 5 carbon atoms or 6 carbon atoms and where the solvent used usually consists of a mixture of two different solvents. This solution of the anthraquinone is usually referred to as the working solution. In this process, the hydrogen peroxide formed in the course of the anthraquinone process is generally separated by extraction from the respective working solution after a hydrogenation/re-oxidation cycle. Said extraction can be performed preferably with essentially pure water, and the crude aqueous hydrogen peroxide solution is obtained. While it is generally possible to further purify the thus obtained crude aqueous hydrogen peroxide solution by distillation, it is preferred, according to the present invention, to use such crude aqueous hydrogen peroxide solution which has not been subjected to purification by distillation. Further, it is generally possible to subject the crude aqueous hydrogen peroxide solution to a further extraction stage wherein a suitable extracting agent, preferably an organic solvent is used. More preferably, the organic solvent used for this further extraction stage is the same solvent which is used in the anthraquinone process. Preferably the extraction is performed using just one of the solvents in the working solution and most preferably using just the most non-polar solvent of the working solution. In case the crude aqueous hydrogen peroxide solution is subjected to such further extraction stage, a so-called crude washed hydrogen peroxide solution is obtained.

Surprisingly, it was found that even traces of anthraquinone and/or derivatives thereof present in the wastewater considerably contribute to the deactivation of the RO membrane. This was an unexpected finding since anthraquinone and/or anthraquinone derivatives may be merely present in concentrations the weight-ppb (weight parts per billion) range in the wastewater compared with other compounds such as glycols which may be present in concentrations which are by several order of magnitude higher.

According to the present invention, it was surprisingly found that in the adsorbing stage (b) of the present invention, anthraquinone and/or anthraquinone derivatives which may be present in the mixture M1, preferably in case the process for the preparation of an olefin oxide is carried out using hydrogen peroxide as epoxidation agent and the hydrogen peroxide is prepared via the anthraquinone process, are selectively adsorbed and thus retained, and although the concentration of anthraquinone and/or anthraquinone derivatives is typically very low, usually in the range of from up to 100 weight-ppb such as from 1 to 100 weight-ppb (weight parts per billion), the adsorption of these low amounts of anthraquinone and/or anthraquinone derivatives in stage (b) can prevent the reverse osmosis membrane from being rapidly deactivated.

Further oxygenates which may be contained in mixture M1 are preferably selected from the group consisting of formaldehyde, formaldehyde dimethyl acetal, acetaldehyde dimethyl acetal, methyl formate, formic acid, acetic acid, and combinations of two or more thereof.

As already mentioned, the hydrogen peroxide used in the preparation of olefin oxides may comprise traces of anthraquinone and/or anthraquinone derivatives. For example, in case propene is reacted with the aqueous hydrogen peroxide solution in the presence of an organic solvent such as methanol or acetonitrile, typically a mixture is obtained comprising the organic solvent, propylene oxide, water, and oxygenate byproducts such as propylene glycol and impurities such as anthraquinone and/or anthraquinone derivatives are obtained. Conveniently, the individual components are separated from propylene oxide depending on their boiling points according to any suitable technique, preferably by evaporation, stripping, distillation, or a combination of two or more thereof. Water having a comparatively high boiling point is usually separated in one or more late stages of the downstream processing. Thereby, a waste water fraction comprising anthraquinone and/or anthraquinone derivatives is obtained which corresponds to the aqueous mixture M1 according to the present invention.

Preferably, anthraquinone and/or anthraquinone derivatives are contained in mixture M1 in an amount in the range of from 1 to 100 weight-ppb (weight parts per billion), preferably from 2 to 80 weight-ppb, preferably from 3 to 60 weight-ppb relative the total weight of the mixture M1.

Therefore, the aqueous mixture M1 preferably contains water in an amount of at least 95 weight-%, more preferably at least 98 weight-%, more preferably at least 99 weight-%, more preferably at least 99.4 weight-% relative to the total weight of the aqueous mixture M1, wherein the aqueous mixture M1 additionally contains at least two oxygenates in an amount in the range of from 0.01 to 1 weight-%, preferably from 0.01 to 0.5 weight-%, more preferably from 0.01 to 0.3 weight-%, more preferably from 0.01 to 0.2 weight-%, wherein at least one of the at least two oxygenates is anthraquinone and/or an anthraquinone derivative which is contained in the aqueous mixture M1 in an amount in the range of from 1 to 100 weight-ppb, and wherein at least one the at least two oxygenates is selected from the group consisting of methanol, ethanol, propanol, methoxypropanol (MOP), monopropylene glycol (MPG), dipropylene glycol (DPG), tripropylene glycol (TPG), dipropylene glycol methyl ether (DPGME), tripropylene glycol monomethyl ether (TPGME), acetaldehyde, and hydroxyacetone, the anthraquinone derivative preferably being selected from the group consisting of 2-ethyl anthraquinone, tetrahydro-2-ethyl anthraquinone, 2-isopropylanthraquinone, 2-sec-butylanthraquinone, 2-t-butylanthraquinone, 2-sec-amylanthraquinone, 1,3-dimethylanthraquinone, 2,3-dimethylanthraquinone, 1,4-dimethyl-anthraquinone, 2,7-dimethylanthraquinone, amylanthraquinone, tetrahydroamylanthraquinone, and combinations of two or more thereof.

As far as the adsorbing agent used according to (a) is concerned, no specific restrictions exist, provided that at least one oxygenate can be adsorbed thereto in the desired amount. Preferably, the adsorbing agent according to (a) is selected from the group consisting of activated carbon, an organic polymer, a silica gel, a molecular sieve, and a combination of two or more thereof.

Activated carbon may be provided as powder or granules following carbonization and activation of carbonaceous source materials.

Organic polymers which may be used as adsorbing agent are preferably microspheres having a diameter of from 0.3 to 0.8 mm with various pore dimensions and surface areas. Organic polymer adsorbing agents are typically obtained by means of styrene, acrylate and divinyl benzene polymerization or copolymerization, having a porous structure that allows the reversible adsorption of organic compounds. Preferably, the organic polymer used in the present invention is a polystyrene-based polymer. More preferably the organic polymer is polystyrene cross-linked with divinyl benzene.

Silica gel is a porous and amorphous form of SiO₂ and may be obtained as powder, granules or beads. It is usually prepared by the reaction between sodium silicate and acetic acid, which is followed by a series of after-treatment processes such as aging, pickling, etc. These aftertreatment methods result in various pore size distributions. The hydroxyl (OH) groups on the surface of silica can be functionalized to afford specialty silica gels that exhibit specific chemical and physical properties.

A molecular sieve may be a natural or synthetic crystalline aluminosilicates which has a repeating pore network. Synthetic molecular sieves can be manufactured by hydrothermal synthesis in an autoclave possibly followed by ion exchange with certain cations such as Na⁺, Li⁺, Ca²⁺, K⁺, or NH₄_{⁺}. Molecular sieves with various pore size distributions may be obtained. The ion exchange process can be followed by drying of the obtained material, which can be optionally pelletized with a binder to form macroporous pellets.

Preferably, the adsorbing agent used according to (a) has a total pore volume in the range of from 0.1 to 3 cm³/g, more preferably from 0.2 to 2.5 cm³/g, more preferably from 0.5 to 1.5 cm³/g, determined according to DIN 66134.

Preferably, the adsorbing agent used according to (a) has a mean pore size in the range of from 5 to 900 Angstrom (1 Angstrom=10⁻¹⁰ m), more preferably from 10 to 600 Angstrom, more preferably from 12 to 300 Angstrom, more preferably from 15 to 100 Angstrom, more preferably from 17 to 70 Angstrom, determined according to DIN 66134.

Preferably, the adsorbing agent used according to (a) has a BET surface area in the range of from 500 to 1500 m²/g, more preferably from 800 to 1450 m²/g, more preferably from 900 to 1400 m²/g, determined according to DIN 66131.

Generally, the contacting in (a) may be carried out in any appropriate way. The contacting may be for example carried out in batch mode or in a semi-continuous mode. It is preferred that the contacting in (a) is performed in continuous mode. Preferably, the adsorbing agent is provided as a stationary bed in a suitable container equipped with suitable filters or frits to avoid the loss of the stationary bed. The container is preferably made of one or more materials which are inert under the contacting conditions in (a). By way of example, glass or stainless steel may be mentioned.

The container in which the adsorbing agent is provided is preferably a tube or column, and is preferably further equipped with pumps, detectors, cooling means, feeding and removal means. Preferably, a container which comprises the adsorbing agent and which is further equipped with pumps, detectors, cooling means, feeding and removal means forms an adsorbing unit used in (a). Preferably, the mixture M1 is introduced in such an adsorbing unit and is passed over the adsorbing agent at a defined flow rate, thereby becoming depleted of an oxygenate. Thus, the mixture M2 is obtained.

Regarding the flow rate of the mixture M1 subjected to contacting in (a), no specific restrictions exist. Preferably, the contacting in (a) is performed at a bed volume (BV) in the range of from 0.01 to 20 h⁻¹, more preferably from 0.05 to 10 h⁻¹, more preferably from 0.1 to 7 h⁻¹, more preferably from 0.3 to 6 h⁻¹, more preferably from 0.5 to 5 h⁻¹, wherein the bed volume (BV) is defined as the ratio of the flow rate of the mixture M1 in liter/h relative to the volume of the adsorbent in liter.

Preferably, the contacting in (a) is performed at a pressure in the range of from 0.7 to 20 bar, preferably from 0.8 to 15 bar, more preferably from 0.9 to 10 bar, more preferably from 1 to 5 bar.

Preferably, the contacting in (a) is performed at a temperature in the range of from 5 to 80° C., preferably from 10 to 60° C., more preferably from 15 to 45° C. Preferably, the contacting is performed at ambient temperature.

Preferably, the contacting in (a) is carried out using 1 to 8 adsorbing units. The contacting in (a) is preferably carried out using 2 to 8 adsorbing units connected in series, preferably using 2 to 6 adsorbing units, such as 2, 3, 4, 5 or 6 adsorbing units connected in series.

### Step (b)

According to step (b) of the present invention, an aqueous mixture M2 is separated from the adsorbing agent, wherein the mixture M2 is depleted of the oxygenate adsorbed in (a).

Preferably, the separating in (b) of the aqueous mixture M2 from the adsorbing agent is obtained by means selected from the group consisting of filtration, centrifugation, decantation, evaporation, and combinations of two or more thereof. More preferably, the aqueous mixture M2, which is obtained following contacting mixture M1 with the adsorbing agent, is separated from the adsorbing agent by filtration, preferably by filtration following passing the mixture M1 over the adsorbing agent preferably comprised as stationary bed in a container provided with filters or frits.

Preferably, at least one oxygenate adsorbed in (a) is anthraquinone and/or an anthraquinone derivative. Preferably, at least 80%, more preferably at least 90%, more preferably at least 95%, more preferably at least 99% of the anthraquinone and/or the anthraquinone derivative contained in the mixture M1 are adsorbed in (a).

The inventors surprisingly found out that by contacting mixture M1 according to step (a) a mixture M2 is obtained which is considerably depleted of anthraquinone and/or anthraquinone derivatives. Specific results showed that by using adsorbents such as activated carbon or polystyrenic resins, anthraquinone and/or anthraquinone derivatives could be retained for at least 2000 hours (about 83 days) at the adsorbing agent. Thus, when passing the mixture M1 at a suitable flow rate over the adsorbing agent, the mixture M2 did not contain anthraquinone and/or anthraquinone derivatives at detectable levels for at least 2000 hours. Thus, for at least 2000 hours the reverse osmosis membrane in the reverse osmosis unit according to (c) did not come into contact with the anthraquinone and/or anthraquinone derivatives.

It was further found out that the adsorbing agents according to the present invention also essentially completely adsorbed glycol ethers contained in the mixture Ml, such as MPG, DPGME or TPGME, which glycol ethers are usually retained by the reverse osmosis unit. Being normally contained in relatively high amounts of from about 0.1 to about 0.5 weight-% in the mixture M1, a break-through of the glycol ethers could be observed after a time period in the range of from about 2 to about 25 hours when using activated carbon or polystyrenic resin as adsorbents. Highly surprising, however, anthraquinone and/or anthraquinone derivatives where still retained far beyond the time at which the adsorbent was already exhausted by glycol ethers. The adsorbents thus turned out to be extremely useful to protect a reverse osmosis unit from detrimental components such as anthraquinone and/or anthraquinone derivatives over a long period of time even in the presence of several orders of magnitude higher amounts of oxygenates competing for a binding to the adsorbing agent.

Further, since for a certain period of time, also other oxygenates are retained according to (b), the present invention also relates to the use of an adsorbing agent, preferably selected from the group consisting of activated carbon, an organic polymer, a silica gel, a molecular sieve, and combinations of two or more thereof, wherein the organic polymer is preferably a polystyrenebased polymer, for replacing a reverse osmosis unit in the treatment of wastewater obtained from a process for the preparation of an olefin oxide, preferably propylene oxide, preferably in the time slot in which a first, preferably at least partially spent reverse osmosis unit downstream of said adsorbing agent is taken out of operation and a second, preferably fresh reverse osmosis unit is taken into operation downstream of said adsorbing agent as, replacing the first reverse osmosis unit.

After the contacting in (a), the TOC of the mixture M2 obtained in (b) relative to the TOC of the mixture M1 is reduced. The TOC of the mixture M2 will depend on the exhaustion state of the adsorbing agent. The TOC of the mixture M2 obtained in (b) may be at most 95%, such as at most 90%, at most 50%, or at most 10% of the TOC of mixture M1. Generally, it is conceivable that the TOC of the mixture M2 obtained in (b) is at most 0.2%, such as at most 0.1%, at most 0.06%, or at most 0.02%, of the TOC of mixture M1.

Thus, it was also found that in particular in its fresh state, the adsorbing agent according to the present invention can replace the reverse osmosis unit over a certain period of time. This finding was found to be very important in particular in large-scale processes where after a certain period of time, an reverse osmosis unit has to be taken out of operation, for example for replacing or regenerating the respective reverse osmosis membrane. In case no parallel reverse osmosis unit is available to which the respective wastewater stream can be switched without interruption of the continuous process, the adsorbing agent according to the present invention can take the role of the reverse osmosis unit for that period of time during which a spent reverse osmosis unit is removed from the stream and a new reverse osmosis unit is taken into operation, since the adsorbing agent, as described, may remove also oxygenates other than anthraquinone and/or anthraquinone derivatives from the mixture M1.

Therefore, the present invention also relates to the use of an adsorbing agent, preferably selected from the group consisting of activated carbon, an organic polymer, a silica gel, a molecular sieve, and combinations of two or more thereof, wherein the organic polymer is preferably a polystyrene-based polymer, for replacing a reverse osmosis unit in the treatment of wastewater obtained from a process for the preparation of an olefin oxide, preferably propylene oxide, preferably in the time slot in which a first, preferably at least partially spent reverse osmosis unit downstream of said adsorbing agent is taken out of operation and a second, preferably fresh reverse osmosis unit is taken into operation downstream of said adsorbing agent as, replacing the first reverse osmosis unit.

### Step (c)

According to step (c) of the present invention, an oxygenate from the mixture M2 obtained in (b) is separated by subjecting the mixture M2 to reverse osmosis in at least one reverse osmosis unit containing a reverse osmosis membrane obtaining an aqueous mixture M3 being depleted of this oxygenate.

Preferably, the reverse osmosis membrane according to (c) is selected from the group consisting of a tubular membrane, a capillary membrane, a spiral membrane, a hollow fiber membrane, and a combination of two or more thereof.

Tubular membranes are non-self-supporting membranes. They are located on the inside of a tube, made of a material which is the supporting layer for the membrane. Because the location of tubular membranes is inside a tube, the flow in a tubular membrane is usually inside out. Tubular membranes generally have a diameter of about 5 to 15 mm.

With capillary membranes the membrane serves as a selective barrier, which is sufficiently strong to resist filtration pressures. Because of this, the flow through capillary membranes can be both inside out and outside in. The diameter of capillary membranes is much smaller than that of tubular membranes, namely 0.5 to 5 mm. Because of the smaller diameter the chances of plugging are much higher with a capillary membrane.

Spiral membranes consist of two layers of membrane, placed onto a permeate collector fabric. This membrane envelope is wrapped around a centrally placed permeate drain. This causes the packing density of the membranes to be higher. The feed channel is placed at moderate height, to prevent plugging of the membrane unit.

The pressurized mixture flows along the external surface of the membrane sleeves. A solution penetrates and flows within the spiral sleeve towards the central pipe that leads it out of the module.

Membranes that consist of flat plates are called pillow-shaped membranes. The name pillowshaped membrane comes from the pillow-like shape that two membranes have when they are packed together in a membrane unit. Inside the ‘pillow’ is a supporting plate, which attends solidity.

Within a module, multiple pillows are placed with a certain distance between them, which depends on the dissolved solids content of the solution. The solution flows through the membranes inside out. After the treatment , the permeate is collected in the space between the membranes, where it is carried away preferably through drains.

According to the present invention, a hollow fiber membrane is to be understood as a membrane having a diameter of at most 0.15 micrometer, preferably at most 0.12 micrometer, more preferably at most 1.0 micrometer.

As membranes, all membranes with a sufficient stability against organic compounds for example membranes having a celluloseacetate, composite or polyamide active layer can be used. Preferably membranes with polyamide active layer as spiral membrane modules are used.

Preferably, the reverse osmosis in (c) is performed in continuous mode.

Preferably, the subjecting in (c) is performed at a permeate flow in the range of from 1 to 20 Kg·m⁻²·h⁻¹, more preferably from 2 to 15 kg·m⁻²·h⁻¹, more preferably from 5 to 10 kg·m⁻²·h⁻¹.

Preferably, the subjecting in (c) is performed at a pressure in the range of from 2 to 100 bar, more preferably of from 5 to 80 bar, more preferably of from 10 to 60 bar, more preferably of from 20 to 50 bar.

Preferably, the subjecting in (c) is performed at a temperature in the range of from 5 to 80° C., more preferably from 10 to 60° C., more preferably from 15 to 50° C.

According to the present invention, the separation step by means of reverse osmosis is preferably carried out using 1 to 8 reverse osmosis units. Reverse osmosis is preferably carried out using 2 to 8 reverse osmosis units connected in parallel, preferably using 4 to 6 reverse osmosis units, for example 5 reverse osmosis units.

In each stage, the weight ratio of the feed relative to retentate is preferably from 10 to 60, for example from 15 to 30.

Preferably, the TOC of the mixture M3 obtained in (c) is at most 0.1%, more preferably at most 0.08%, more preferably at most 0.05%, more preferably at most 0.01% of the TOC of mixture M1.

### Step (d)

The process of the present invention preferably further comprises (d) submitting the mixture M3 obtained in (c) to a biological wastewater treatment.

By submitting the mixture M3 obtained in (c) to a biological wastewater treatment, the TOC is preferably even further reduced.

Other chemical measures of water quality except the TOC include dissolved oxygen (DO), chemical oxygen demand (COD), biochemical oxygen demand (BOD), total dissolved solids (TDS), pH, nutrients (nitrates and phosphorus), heavy metals and pesticides.

Specific maximum limits for these parameters are determined by the intended use (e.g. human consumption, industrial use or environment) of the treated water and are set by the responsible authorities on the basis of widely accepted guidelines. Industrial wastewater which is following a biological treatment within set standards may be for example reused or safely released into an appropriate watercourse.

Biological wastewater treatment is based on the natural role of bacteria to close the elemental cycles (e.g. C, N, P). In a wastewater treatment plant naturally occurring microorganisms may be used. By engineering the system, natural limitations for bioconversion such as limited aeration and limited amount of biomass can be overcome. Furthermore, the design of biological processes is based on the creation and exploitation of ecological niches that select for microorganisms best adapted to reproduce under such environmental conditions. Selective pressure may arise from various conditions of availability of electron donor (most often organic matter), electron acceptor (such as oxygen or nitrate), nutrients, pH, temperature, or other conditions.

Organisms found in wastewater and wastewater treatment plants include mainly microorganisms (viruses, bacteria, protozoa) and some higher organisms (algae, plants, animals).

Preferably, the biological wastewater treatment in (d) comprises contacting mixture M3 with aerobic and/or anaerobic microorganisms.

Heterotrophic aerobic microorganisms oxidize organic substances with the aid of oxygen to CO2 or some other metabolic product, thereby utilizing organic materials as a carbon source for creating new cell substance. Other metabolic processes of interest include ammonification, nitrification, denitrification, and phosphorus elimination.

Biodegradation of organic compounds is usually achieved by treatment processes such as activated sludge, trickling filter or a combination thereof. Specifically, one or more activated sludge units and/or one or more trickling filter units may be connected in series.

The activated sludge process comprises combining of wastewater comprising organic carbon with air and a biological floc comprising the microorganisms. The general arrangement of an activated sludge process for removing organic carbon includes an aeration tank where air (or oxygen) is injected in the wastewater containing the biological floc and a settling tank to allow the biological flocs to settle, thus separating the microorganisms from the clear treated water. Treatment of nitrogenous matter or phosphate would involve additional steps where wastewater containing the biological floc is left in anoxic conditions (no residual dissolved oxygen).

The trickling filter process comprises passing the wastewater over a fixed bed of porous materials with a high surface area such as rocks, coke or plastic foam covered with a layer of microorganisms. Aerobic conditions are maintained by splashing, diffusion, and either by forced air flowing through the bed or natural convection of air if the filter medium is porous. The biofilm on the trickling filter itself is not homogeneous. The aerobic surface layer consumes mainly the organic carbon and oxygen. Below this layer is an anoxic layer (oxygen-free), in which denitrification occurs, or even an anaerobic layer. As the biofilm layer thickens, it eventually sloughs off into the treated wastewater. Typically, a trickling filter is followed by a clarifier or sedimentation tank for the separation and removal of the sloughing.

The biosolids separated from the wastewater an activated sludge or trickling filter process are further treated by submitting to anaerobic and/or aerobic digestion.

It is conceivable that for the reduction of the TOC in wastewater originating from an epoxidation reaction, suitable microorganisms must be present which are capable to degrade the specific organic compounds comprised therein. For that, naturally occurring microorganisms adapt themselves to these substrates over time. The adaptation is based by regulation or activation of enzymes present, induction or new formation of enzymes, appearance of new bacteria by mutation and/or plasmid transfer, and selection and growth of adapted microorganisms. In the meantime a number of microorganisms have been identified which are capable to degrade organic compounds such as glycols or glycol ethers.

### Preparation of the Olefin Oxide

As already mentioned, different variants of a process for the preparation of an olefin oxide, preferably by reacting an olefin with an aqueous hydrogen peroxide solution in the presence of an organic solvent and a heterogeneous catalyst may be established. Also, the downstream processing may be altered and adapted according to the individual requirements and already existing settings. This implies that wastewater representing a mixture M1 subjected to the purification process of the present invention may be obtained and collected following different reaction and workup routes.

The reaction of the olefin with hydroperoxide in an organic solvent catalyzed by a heterogeneous catalyst takes place in a reactor suitable for this purpose. The starting materials can be introduced individually into the reactor or preferably be combined to form a single stream before being fed into the reactor. Starting materials are olefin, preferably propene, organic solvent, preferably methanol and/or acetonitrile, and hydroperoxide, preferably an aqueous hydrogen peroxide solution.

The term “a reactor” is not restricted to a single vessel. Rather, it is also possible to use a cascade of stirred vessels as reactor. Preference is given to using fixed-bed reactor as reactors. The fixed-bed reactors used are more preferably fixed-bed tube reactors. Preferably, the fixed-bed reactor comprises the heterogeneous catalyst. The heterogeneous catalyst is typically present in the form of extrudates or pressed pellets.

The heterogeneous catalyst contains preferably at least one a zeolite catalyst. As far as the at least one zeolite catalyst is concerned, generally not limitations exist. Preferably, a zeolite containing titanium is employed. Such titanium zeolites have preferably a crystalline structure selected from the group consisting of MFI, MEL, MWW, BEA or mixed structures thereof. Further preferred are zeolite catalysts containing titanium that are referred to, in general, as “TS-1”, “TS-2” or “TS-3”, as well as zeolites containing titanium displaying a structure that is isomorphous to zeolite beta.

The downstream processing of the reaction mixture obtained by reacting an olefin with hydroperoxide in an organic solvent catalyzed by a heterogeneous catalyst is preferably a combination of suitable separation steps, such as condensation, compression, vaporization, stripping, or distillation. The separation is generally regulated by controlling temperature and pressure of the reaction mixture. The separation may be carried out using any apparatus known to a person skilled in the art for this purpose. It may be carried out either continuously or batchwise. Conveniently, for the separation of the individual compounds a succession of apparatuses such as heat exchangers, compressors, evaporators, stripping columns or distillation columns or may be used. In addition, individual compounds may be chemically converted into a more easily removable compound prior to separation.

Heat exchangers can have essentially any configuration. Examples of configurations are shell-and-tube heat exchangers, coil heat exchangers or plate heat exchangers. As coolant any conceivable medium can be employed. Preferred coolants are, among others, common river water or secondary coolants such as secondary cooling water.

Example for suitable compressors are piston compressors, diaphragm compressors, screw compressors and rotary compressors. It is possible to use different apparatuses for each compression step.

Vaporizers are used to turn selectively a compound from a liquid mixture into its gaseous form which is removed form the rest of the mixture and condensed. Suitably, a forced circulation vaporizer may be employed, wherein a pump is used to increase circulation of the vapor to be condensed and separated in the apparatus. Alternatively, flash evaporation may be employed. Flash evaporation is the partial vapor that occurs when a saturated liquid stream undergoes a reduction in pressure by passing through a throttling device. If the throttling device is located at the entry into a pressure vessel so that the flash evaporation occurs within the vessel, then the vessel is often referred to as a flash drum. If the saturated liquid is a multi-component liquid, the flashed vapor is richer in the more volatile components than is the remaining liquid mixture.

Stripping is a separation process wherein one more components are removed from a liquid mixture by a vapor stream. In industrial applications the liquid and vapor streams usually have co-current or countercurrent flows. Stripping may be carried out using packed or trayed columns to increase to contact area between the liquid phase usually introduced at the top of the column and flowing downwards and the gas phase usually introduced at the bottom and exiting at the top.

Preferred distillation applications include both batch and continuous fractional, vacuum, azeotropic, extractive, and steam distillation. It is possible to use different distillation applications for each separation step. Preferably, the distillation is performed in continuous mode. Preferably, the distillation is selected from the group consisting of continuous fractional distillation and continuous extractive distillation.

In fractional distillation, a mixture is heated up and introduced into a distillation column. On entering the column, the feed starts flowing down but part of it, the component(s) with lower boiling point(s), vaporizes and rises. As it rises, it cools and while part of it continues up as vapor, a part which is enriched in the less volatile component begins to descend again. Preferably, for an improved separation, the fractional distillation is performed in a packed column containing random packing or ordered packing or as a tray column. Preferably, for further improving the separation, reflux is used in fractional distillation, wherein a portion of the condensed overhead liquid product is returned to the distillation column.

The method of extractive distillation uses generally a separation solvent which has a high boiling point and is miscible with the mixture to be separated, but does not form an azeotropic mixture. Preferably, the extractive distillation is performed in counter current, wherein the liquid separation solvent is introduced at the upper part of a separation column and a gaseous compound mixture is introduced at the lower part of the separation column. The solvent interacts differently with the components of the mixture thereby causing their relative volatilities to change. This enables the new three-part mixture to be separated by normal distillation. The original component with the greatest volatility is separated as top product. The bottom product consists of a mixture of the solvent and the other component, which can again be separated easily because the solvent does not form an azeotrope with it. For an improved separation, the extractive distillation is preferably performed in packed column containing random packing or ordered packing or as a tray column. Preferably, for a further improved separation, a portion of the mixture of the solvent and the other component is recirculated into the column above the section wherein the gaseous compound mixture is introduced.

According to the present invention, preferably, the process for the preparation of an olefin oxide is a process for the preparation of propylene oxide and comprises
(i) providing a mixture comprising an organic solvent, preferably methanol or acetonitrile, more preferably methanol, propene, optionally propane, an epoxidation agent, preferably hydrogen peroxide, more preferably hydrogen peroxide prepared according to an anthraquinone process;
(ii) subjecting the mixture provided in (i) to epoxidation conditions in the presence of a catalyst, the catalyst preferably comprising a titanium zeolite, more preferably comprising a titanium silicalite-1 or a titanium zeolite having MWW framework structure, more preferably comprising a titanium silicalite-1, obtaining a mixture comprising the organic solvent, propylene oxide, water, at least one oxygenate as defined above preferably including anthraquinone and/or an anthraquinone derivative, optionally propene, and optionally propane;
(iii) optionally separating propene and propane from the mixture obtained from (ii) obtaining a mixture being depleted of propene and optionally propane, and comprising water, propylene oxide, the organic solvent, at least one oxygenate as defined above preferably including anthraquinone and/or an anthraquinone derivative and preferably including propylene glycol;
(iv) separating propylene oxide from the mixture obtained in (ii) or (iii), preferably from the mixture obtained in (iii), obtaining a mixture being depleted of propylene oxide and comprising water, the organic solvent, at least one oxygenate as defined above preferably including anthraquinone and/or an anthraquinone derivative and preferably including propylene glycol;
(v) separating the organic solvent from the mixture obtained in (iv), obtaining a mixture being depleted of the organic solvent and comprising water, at least one oxygenate as defined above preferably including anthraquinone and/or an anthraquinone derivative and preferably including propylene glycol;
(vi) preferably subjecting the mixture obtained in (v) to a propylene glycol removal stage, preferably comprising
   (I) evaporating the mixture in at least two evaporation and/or distillation stages at decreasing operating pressures of the evaporators and/or distillation columns obtaining a mixture (M′) and a mixture (M″);
   (II) separating the mixture (M′) obtained in (I) in at least one further distillation step, obtaining a mixture (M-I) being enriched in water, preferably comprising at least 70 weight-% of water, and a mixture (M-II) being depleted of water, preferably comprising at most 30 weight-% of water;
   (III) separating propylene glycol from the mixture (M-II) in at least one further distillation step obtaining a mixture being depleted of propylene glycol and comprising water and at least one oxygenate as defined above preferably including anthraquinone and/or an anthraquinone derivative;
      wherein the mixture obtained from (v) or the mixture obtained from (vi)(III), preferably the mixture obtained from (vi)(III), is the aqueous mixture Ml.

In step (iii), unreacted propene and optionally propane may be separated from the mixture obtained from (ii) thereby obtaining a mixture being depleted of propene and optionally propane and comprising water, propylene oxide, the organic solvent, at least one oxygenate as defined above preferably including anthraquinone and/or an anthraquinone derivative and preferably including propylene glycol. The depletion of the mixture obtained from (ii) of propene and optionally propane may be accomplished in different ways. Preferably, propene and optionally propane are separated by submitting the mixture obtained from (ii) to fractional distillation, thereby obtaining an overhead product enriched in propene and optionally propane and a bottom product depleted of propene and optionally propane and comprising water, propylene oxide, the organic solvent, at least one oxygenate as defined above preferably including anthraquinone and/or an anthraquinone derivative and preferably including propylene glycol. In the alternative, the reaction mixture obtained from (ii) is preferably separated in an evaporator into an overhead product enriched in propene and optionally propane and a bottom product depleted of propene and optionally propane and comprising water, propylene oxide, the organic solvent, at least one oxygenate as defined above preferably including anthraquinone and/or an anthraquinone derivative and preferably including propylene glycol. It is conceivable that propene and optionally propane may also be separated by extractive distillation using a hydrocarbon with a boiling point of about 200 to 300° C. as adsorbent. The separation of propene and optionally propane is carried out under the general conditions in respect of pressure, temperature and residence time with which a person skilled in the art is familiar.

In step (iv), propylene oxide is separated from the mixture obtained in (ii) or (iii), preferably from the mixture obtained in (iii), thereby obtaining a mixture being depleted of propylene oxide and comprising water, the organic solvent, at least one oxygenate as defined above preferably including anthraquinone and/or an anthraquinone derivative and preferably including propylene glycol. Preferably, the propylene oxide is separated by submitting the mixture obtained in (ii) or (iii), preferably the mixture obtained in (iii) to distillation, thereby obtaining an overhead product enriched in propylene oxide and a bottom product depleted of propylene oxide and comprising water, the organic solvent, at least one oxygenate as defined above preferably including anthraquinone and/or an anthraquinone derivative and preferably including propylene glycol. Preferably, the propylene oxide is separated by extractive distillation. In this connection, the mixture obtained (ii) or (iii), preferably in (iii), is added to the middle section of an extractive distillation column and a polar solvent with hydroxyl functionality and having a boiling point higher than that of the organic solvent comprised in (ii) or (iii), preferably in (iii), is added to the extractive distillation column at a point above the point at which the mixture obtained in (ii) or (iii), preferably in (iii), enters the column. An overhead product enriched in propylene oxide is distilled of the at the head of the column and a mixture comprising water, the organic solvent, at least one oxygenate as defined above preferably including anthraquinone and/or an anthraquinone derivative and preferably including propylene glycol and further the polar solvent with hydroxyl functionality is extracted as bottom product. The preferred polar solvent with hydroxyl functionality is water. The separation of propylene oxide is carried out under the general conditions in respect of pressure, temperature and residence time with which a person skilled in the art is familiar.

In step (v), the organic solvent, preferably methanol or acetonitrile, more preferably methanol, is separated from the mixture obtained in (iv), obtaining a mixture being depleted of the organic solvent and comprising water, at least one oxygenate as defined above preferably including anthraquinone and/or an anthraquinone derivative and preferably including propylene glycol. Preferably, the organic solvent is separated by submitting the mixture obtained in (iv) to fractional distillation, thereby obtaining an overhead product enriched in organic solvent and a bottom product depleted of organic solvent and comprising water, at least one oxygenate as defined above preferably including anthraquinone and/or an anthraquinone derivative and preferably including propylene glycol. The separation of the organic solvent is carried out under the general conditions in respect of pressure, temperature and residence time with which a person skilled in the art is familiar.

In step (vi), the mixture obtained in (v) may be further submitted to a propylene glycol removal stage. The propylene glycol removal stage in (vi) preferably comprises at least two evaporation and/or distillation stages. Thus, the propylene glycol removal stage in (iv) preferably comprises
(I) evaporating the mixture obtained in (v) in at least two evaporation and/or distillation stages at decreasing operating pressures of the evaporators and/or distillation columns obtaining a mixture (M′) and a mixture (M″);
(II) separating the mixture (M′) obtained in (I) in at least one further distillation step, obtaining a mixture (M-I) being enriched in water, preferably comprising at least 70 weight-% of water, and a mixture (M-II) being depleted of water, preferably comprising at most 30 weight% of water;
(III) separating propylene glycol from the mixture (M-II) in at least one further distillation step obtaining a mixture being depleted of propylene glycol and comprising water and preferably anthraquinone and/or an anthraquinone derivative.
   The distillation performed in steps (I) to (III) is preferably a fractional distillation.

Thus, the mixture obtained from (v) or the mixture obtained from (vi)(III), preferably the mixture obtained from (vi)(III), is the aqueous mixture Ml.

Preferably, the wastewater purified according to the process of the present invention is obtained according to the process for the preparation of an olefin oxide comprising the steps (i) to (v), preferably according to the process for the preparation of an olefin oxide comprising the steps (i) to (vi).

The present invention further refers to purified wastewater obtainable or obtained by the process of the present invention having a content of anthraquinone and/or anthraquinone derivatives, preferably of anthraquinone, of preferably at most 10 weight-ppb, more preferably at most 5 weight-ppb, more preferably at most 3 weight-ppb, relative to the total weight of the purified wastewater.

The present invention is further characterized by the following embodiments and the combinations of embodiments as indicated by the respective dependencies.
1. A process for reducing the total organic carbon (TOC) in an aqueous mixture M1 obtained as wastewater from a process for the preparation of an olefin oxide, the process for reducing the TOC comprising:
   (a) contacting the mixture M1 which contains at least one oxygenate having from 1 to 16 carbon atoms with an adsorbing agent and adsorbing at least a portion of an oxygenate at the adsorbing agent;
   (b) separating an aqueous mixture M2 from the adsorbing agent, the mixture M2 being depleted of the oxygenate adsorbed in (a);
   (c) separating an oxygenate from the mixture M2 obtained in (b) by subjecting the mixture M2 to reverse osmosis in at least one reverse osmosis unit containing a reverse osmosis membrane obtaining an aqueous mixture M3 being depleted of this oxygenate.
2. The process of embodiment 1, wherein the aqueous mixture M1 contains water in an amount of at least 95 weight-%, preferably at least 98 weight-%, more preferably at least 99 weight-%, more preferably at least 99.4 weight-% relative to the total weight of the aqueous mixture M1.
3. The process of embodiment 1 or 2, wherein the aqueous mixture M1 contains the at least one oxygenate in an amount of at most 1 weight-%, preferably at most 0.5 weight-%, more preferably at most 0.3 weight-%, more preferably at most 0.2 weight-%, relative to the total weight of the aqueous mixture Ml.
4. The process of any of embodiments 1 to 3, wherein the at least one oxygenate contained in the mixture M1 is selected from the group consisting of alcohols, ethers, aldehydes, ketones, and combinations of two or more thereof.
5. The process of any of embodiments 1 to 4, wherein the at least one oxygenate contained in the mixture M1 is selected from the group consisting of methanol, ethanol, propanol, methoxypropanol (MOP), monopropylene glycol (MPG), dipropylene glycol (DPG), tripropylene glycol (TPG), dipropylene glycol methyl ether (DPGME), tripropylene glycol monomethyl ether (TPGME), acetaldehyde, hydroxyacetone, anthraquinone, anthraquinone derivatives, and combinations of two or more thereof.
6. The process of any of embodiments 1 to 5, wherein the adsorbing agent according to (a) is selected from the group consisting of activated carbon, an organic polymer, a silica gel, a molecular sieve, and combinations of two or more thereof.
7. The process of embodiment 6, wherein the organic polymer is a polystyrene-based polymer.
8. The process of any of embodiments 1 to 7, wherein the adsorbing agent according to (a) has a total pore volume in the range of from 0.1 to 3 cm³/g, preferably from 0.2 to 2.5 cm³/g, more preferably from 0.5 to 1.5 cm³/g, determined according to DIN 66134.

9. The process of any of embodiments 1 to 8, wherein the adsorbing agent according to (a) has a mean pore size in the range of from 5 to 900 Angstrom, preferably from 10 to 600 Angstrom, more preferably from 12 to 300 Angstrom, more preferably from 15 to 100 Angstrom, more preferably from 17 to 70 Angstrom, determined according to DIN 66134.

10. The process of any of embodiments 1 to 9, wherein the adsorbing agent according to (a) has a BET surface area in the range of from 500 to 1500 m²/g, preferably from 800 to 1450 m²/g, more preferably from 900 to 1400 m²/g, determined according to DIN 66131.
11. The process of any of embodiments 1 to 10, wherein the contacting in (a) is performed in continuous mode, wherein the mixture M1 is passed over the adsorbing agent provided in a suitable container.
12. The process of embodiment 11, wherein the contacting in (a) is performed with a bed volume in the range of from 0.1 to 7.0 h⁻¹, preferably from 0.3 to 6 h⁻¹, more preferably 0.5 to 5 h⁻¹, wherein the bed volume is defined as the ratio of the flow rate of the mixture M1 in liter/h relative to the volume of the adsorbing agent in liter.
13. The process of any of embodiments 1 to 12, wherein the contacting in (a) is performed at a pressure in the range of from 0.7 to 20 bar, preferably from 0.8 to 15 bar, more preferably from 0.9 to 10 bar, more preferably from 1 to 5 bar.
14. The process of any of embodiments 1 to 13, wherein the contacting in (a) is performed at a temperature in the range of from 5 to 80° C., preferably from 10 to 60° C., more preferably from 15 to 45° C.
15. The process of any of embodiments 1 to 14, wherein an oxygenate adsorbed in (b) is anthraquinone and/or an anthraquinone derivative and wherein preferably at least 80%, more preferably at least 90%, more preferably at least 95%, more preferably at least 99% of the anthraquinone and/or the anthraquinone derivative contained in the mixture M1 are adsorbed in (a).
16. The process of any of embodiments 1 to 15, wherein the TOC of the mixture M2 obtained in (b) is at most 0.2%.
17. The process of any of embodiments 1 to 16, wherein the reverse osmosis membrane according to (c) is selected from the group consisting of a tubular membrane, a capillary membrane, a spiral membrane, a hollow fiber membrane, and a combination of two or more thereof.
18. The process of any of embodiments 1 to 17, wherein the reverse osmosis in (c) is performed in continuous mode.
19. The process of embodiment 18, wherein the subjecting in (c) is performed at a permeate flow in the range of from 1 to 20 kg·m⁻²·h⁻¹, preferably from 2 to 15 kg·m⁻²·h⁻¹, more preferably from 5 to 10 kg·m⁻²·h⁻¹.
20. The process of any of embodiments 1 to 19, wherein the subjecting in (c) is performed at a pressure in the range of from 2 to 100 bar, preferably from 5 to 80 bar, more preferably from 10 to 60 bar, more preferably from 20 to 50 bar.
21. The process of any of embodiments 1 to 20, wherein the subjecting in (c) is performed at a temperature in the range of from 5 to 80° C., preferably from 10 to 60° C., more preferably from 15 to 50° C.
22. The process of any of embodiments 1 to 21, wherein the TOC of the mixture M3 obtained in (c) is at most 0.1%, preferably at most 0.08%, more preferably at most 0.05%, more preferably at most 0.01% of the TOC of the mixture M1.
23. The process of any of embodiments 1 to 22, further comprising (d) subjecting the mixture M3 obtained in (c) to a biological wastewater treatment, obtaining a mixture M4.
24. The process of embodiment 23, wherein the biological wastewater treatment in (d) comprises contacting the mixture M3 with aerobic and/or anaerobic microorganisms.
25. The process of any of claims 1 to 24, wherein the aqueous mixture M1 is obtained as wastewater from a process for the preparation of an olefin oxide wherein the olefin oxide is obtained from the respective olefin, by epoxidation with hydrogen peroxide which is preferably prepared according to an anthraquinone process.
26. The process of any of claims 1 to 25, wherein the olefin oxide is propylene oxide and the olefin is propene.
27. The process of any of embodiments 1 to 26, wherein the process for the preparation of an olefin oxide is a process for the preparation of propylene oxide and comprises
   (i) providing a mixture comprising an organic solvent, preferably methanol or acetonitrile, more preferably methanol, propene, optionally propane, an epoxidation agent, preferably hydrogen peroxide, more preferably hydrogen peroxide prepared according to an anthraquinone process;
   (ii) subjecting the mixture provided in (i) to epoxidation conditions in the presence of a catalyst, the catalyst preferably comprising a titanium zeolite, more preferably comprising a titanium silicalite-1 or a titanium zeolite having MWW framework structure, more preferably comprising a titanium silicalite-1, obtaining a mixture comprising the organic solvent, propylene oxide, water, at least one oxygenate as defined in embodiments 4 and 5 preferably including anthraquinone and/or an anthraquinone derivative, optionally propene, and optionally propane;
   (iii) optionally separating propene and propane from the mixture obtained from (ii) obtaining a mixture being depleted of propene and optionally propane, and comprising water, propylene oxide, the organic solvent, at least one oxygenate as defined as defined in embodiments 4 and 5 preferably including anthraquinone and/or an anthraquinone derivative and preferably including propylene glycol;
   (iv) separating propylene oxide from the mixture obtained in (ii) or (iii), preferably from the mixture obtained in (iii), obtaining a mixture being depleted of propylene oxide and comprising water, the organic solvent, at least one oxygenate as defined as defined in embodiments 4 and 5 preferably including anthraquinone and/or an anthraquinone derivative and preferably including propylene glycol;
   (v) separating the organic solvent from the mixture obtained in (iv), obtaining a mixture being depleted of the organic solvent and comprising water, at least one oxygenate as defined as defined in embodiments 4 and 5 preferably including anthraquinone and/or an anthraquinone derivative and preferably including propylene glycol;
   (vi) preferably subjecting the mixture obtained in (v) to a propylene glycol removal stage, preferably comprising
      (I) evaporating the mixture in at least two evaporation and/or distillation stages at decreasing operating pressures of the evaporators and/or distillation columns obtaining a mixture (M′) and a mixture (M″);
      (II) separating the mixture (M′) obtained in (I) in at least one further distillation step, obtaining a mixture (M-I) being enriched in water, preferably comprising at least 70 weight-% of water, and a mixture (M-II) being depleted of water, preferably comprising at most 30 weight-% of water;
      (III) separating propylene glycol from the mixture (M-II) in at least one further distillation step obtaining a mixture being depleted of propylene glycol and comprising water and at least one oxygenate as defined as defined in embodiments 4 and 5 preferably including anthraquinone and/or an anthraquinone derivative;
         wherein the mixture obtained from (v) or the mixture obtained from (vi)(III), preferably the mixture obtained from (vi)(III), is the aqueous mixture Ml.
28. A process for reducing the total organic carbon (TOC) in an aqueous mixture obtained as wastewater from a process for the preparation of propylene oxide, comprising
   (i) providing a mixture comprising an organic solvent, preferably methanol or acetonitrile, more preferably methanol, propene, optionally propane, an epoxidation agent, preferably hydrogen peroxide, more preferably hydrogen peroxide prepared according to an anthraquinone process;
   (ii) subjecting the mixture provided in (i) to epoxidation conditions in the presence of a catalyst, the catalyst preferably comprising a titanium zeolite, more preferably comprising a titanium silicalite-1 or a titanium zeolite having MWW framework structure, more preferably comprising a titanium silicalite-1, obtaining a mixture comprising the organic solvent, propylene oxide, water, at least one oxygenate as defined as defined in embodiments 4 and 5 preferably including anthraquinone and/or an anthraquinone derivative, optionally propene, and optionally propane;
   (iii) optionally separating propene and propane from the mixture obtained from (ii) obtaining a mixture being depleted of propene and optionally propane, and comprising water, propylene oxide, the organic solvent, at least one oxygenate as defined as defined in embodiments 4 and 5 preferably including anthraquinone and/or an anthraquinone derivative and preferably including propylene glycol;
   (iv) separating propylene oxide from the mixture obtained in (ii) or (iii), preferably from the mixture obtained in (iii), obtaining a mixture being depleted of propylene oxide and comprising water, the organic solvent, at least one oxygenate as defined as defined in embodiments 4 and 5 preferably including anthraquinone and/or an anthraquinone derivative and preferably including propylene glycol;
   (v) separating the organic solvent from the mixture obtained in (iv), obtaining a mixture M1′ being depleted of the organic solvent and comprising water, at least one oxygenate as defined in embodiments 4 and 5 preferably including anthraquinone and/or an anthraquinone derivative and preferably including propylene glycol;
   (vi) preferably subjecting the mixture M1′ obtained in (v) to a propylene glycol removal stage, preferably comprising
      (I) evaporating the mixture in at least two evaporation and/or distillation stages at decreasing operating pressures of the evaporators and/or distillation columns obtaining a mixture (M′) and a mixture (M″);
      (II) separating the mixture (M′) obtained in (I) in at least one further distillation step, obtaining a mixture (M-I) being enriched in water, preferably comprising at least 70 weight-% of water, and a mixture (M-II) being depleted of water, preferably comprising at most 30 weight-% of water;
      (III) separating propylene glycol from the mixture (M-II) in at least one further distillation step obtaining a mixture M1″ being depleted of propylene glycol and comprising water and at least one oxygenate as defined in embodiments 4 and 5 preferably including anthraquinone and/or an anthraquinone derivative;
   (vii) contacting the mixture M1′, preferably the mixture M1″, containing the at least one oxygenate as defined in embodiments 4 and 5 preferably including anthraquinone and/or an anthraquinone derivative, with an adsorbing agent and adsorbing at least a portion of an oxygenate at the adsorbing agent, wherein the at least one oxygenate contained in the mixture is preferably selected from the group consisting of methanol, ethanol, propanol, methoxypropanol (MOP), monopropylene glycol (MPG), dipropylene glycol (DPG), tripropylene glycol (TPG), dipropylene glycol methyl ether (DPGME), tripropylene glycol monomethyl ether (TPGME), acetaldehyde, hydroxyacetone, anthraquinone, anthraquinone derivatives, and combinations of two or more thereof, the at least one oxygenate preferably comprising anthraquinone, anthraquinone derivatives, and combinations of two or more thereof, more preferably comprising anthraquinone;
   (viii) separating an aqueous mixture M2 from the adsorbing agent, the mixture M2 being depleted of the oxygenate adsorbed in (vii), preferably being depleted of anthraquinone, anthraquinone derivatives, and combinations of two or more thereof, more preferably being depleted of anthraquinone, wherein the TOC of the mixture M2 is at most 0.2%;
   (ix) separating an oxygenate from the mixture M2 by subjecting the mixture M2 to reverse osmosis in at least one reverse osmosis unit containing a reverse osmosis membrane obtaining an aqueous mixture M3 being depleted of this oxygenate, wherein the TOC of the mixture M3 is at most 0.1%, preferably at most 0.08%, more preferably at most 0.05%, more preferably at most 0.01% of the TOC of the mixture M1′ or M1″, preferably M1″;
   (x) optionally subjecting the mixture M3 to a biological wastewater treatment, obtaining a mixture M4.
29. A purified wastewater, obtainable or obtained as an aqueous mixture M3 or M4 by a process according to any of embodiments 1 to 28, having a content of anthraquinone and/or anthraquinone derivatives, preferably of anthraquinone, of at most 10 weight-ppb, preferably at most 5 weight-ppb, more preferably at most 3 weight-ppb, relative to the total weight of the purified wastewater.
30. Use of an adsorbing agent, preferably selected from the group consisting of activated carbon, an organic polymer, a silica gel, a molecular sieve, and combinations of two or more thereof, wherein the organic polymer is preferably a polystyrene-based polymer, for replacing a reverse osmosis unit in the treatment of wastewater obtained from a process for the preparation of an olefin oxide, preferably propylene oxide.
31. The use of embodiment 30 in the time slot in which a first, preferably at least partially spent reverse osmosis unit downstream of the adsorbing agent is taken out of operation and a second, preferably fresh reverse osmosis unit is taken into operation downstream of the adsorbing agent, replacing the first reverse osmosis unit.

The wastewater purified according to the process of the present invention may be suitably reused, for example in an industrial process, or may be released safely into the environment.

The present invention is further illustrated by the following figures and examples.

### BRIEF DESCRIPTION OF THE FIGURES

FIG. 1 shows the concentrations of MPG (diamonds), DPGME (bordered squares) and TPGME (simple squares) in a mixture M2 in weight-% relative to the total weight of aqueous mixture M2 following contacting a mixture M1 continuously with activated carbon for 30 hours. The x axis shows the time in hours, the y axis shows the effluent concentrations in weight-% (wt.-%).

FIG. 2 shows the concentrations of MPG (diamonds), DPGME (bordered triangles), TPGME (squares) and anthraquinone (circles) in a mixture M2 in weight-% relative to the total amount of aqueous mixture M2 following contacting a mixture M1 continuously with activated carbon for 2000 hours. The x axis shows the time in hours, the y axis shows the effluent concentrations in weight-% (wt.-%).

FIG. 3 shows the concentrations of MPG (diamonds), DPGME (squares), TPGME (triangles) and anthraquinone (squared asterisks) in a mixture M2 in weight-% relative to the total amount of aqueous mixture M2 following contacting a mixture M1 continuously with a polystyrenic resin for 24 hours. The x axis shows the time in hours, the y axis shows the effluent concentrations in weight-% (wt.-%).

FIG. 4 shows the concentrations of MPG (diamonds), DPGME (squares), TPGME (triangles) and anthraquinone (squared asterisks) in a mixture M2 in weight-% relative to the total amount of aqueous mixture M2 following contacting a mixture M1 with a polystyrenic resin for 1500 hours. The x axis shows the time in hours, the y axis shows the effluent concentrations in weight-% (wt.-%).

FIG. 5 shows the TOC of a mixture M2 in weight-ppm as a function of the runtime of a wastewater treatment as described in Example 3. The x axis shows the time in hours, with tickmarks at 0.0, 50.0, and 100.0 h), the y axis shows the TOC of the effluentein weight-ppm.

### EXAMPLES

### Example 1

### Reduction of TOC in Wastewater Using Activated Carbon

Wastewater containing MPG, DPGME, TPGME and anthraquinone in the amounts indicated below in Table 1 representing a mixture M1 was obtained from a large scale propylene oxide production plant, following the downstream processing of a reaction mixture obtained by oxidizing propene with hydrogen peroxide to propylene oxide using a heterogeneous zeolitic catalyst comprising titanium silicalite-1.

TABLE 1

| Component | Amount in mixture M1 | |
|---|---|---|
| MPG | 0.05 | weight-% |
| DPGME | 0.30 | weight-% |
| TPGME | 0.03 | weight-% |
| Anthraquinone | 48 | weight-ppb |
| TOC | 0.2 | weight-% |
| Water | 99.42 | weight-% |

The amounts of the oxygenates MPG, DPGME and TPGME and the TOC were determined for mixture M1 and further for mixture M2 relative to the total amounts of the respective mixtures. Mixture M2 was obtained following contacting mixture M1 continuously with activated carbon. MPG, DPGME and TPGME concentrations were determined by gas chromatography using an internal standard. The anthraquinone amount was determined by high pressure liquid chromatography (HPLC). The TOC was determined according to DIN EN 1484 by thermal catalytic oxidation with subsequent NDIR (nondispersive infrared) detection using a DIMATOC 2000 analyzer (DIMATEC Analysentechnik GmbH, Essen).

A chromatography column of stainless steel with a length of 62 cm and an inner diameter of 16 mm was packed with 53.4 g granulated activated charcoal (GAC, Cyclocarb 401, Chemviron Carbon GmbH). The GAC was held in place by a 1 cm long portion of glass wool placed at the top and bottom of the tube, respectively.

The mixture M1 was passed at ambient temperature over the GAC with a bed volume (BV) of 4.6 h⁻¹. Accordingly, the contact time was 13 min. The contacting was performed and monitored for 2000 hours in total.

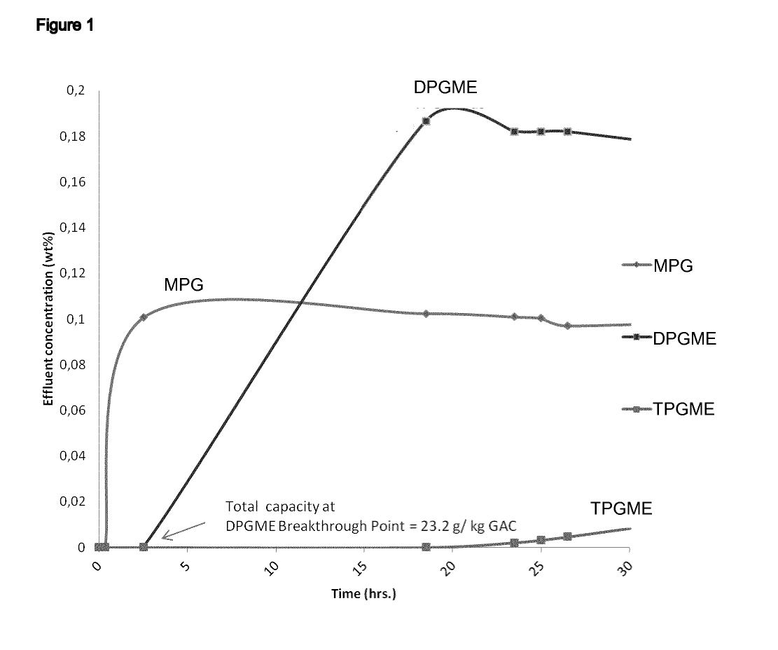

FIG. 1 shows the MPG (diamonds), DPGME (bordered squares) and TPGME (simple squares) concentrations in the mixture M2 obtained following a continuous contacting of mixture M1 with the activated carbon for the first 30 hours. MPG was not retained by the GAC, whereas DPMGE was retained for about 2.5 hours and a beginning of a break-through for TPMGE was observed after about 25 hours. Thus, the TOC was considerably reduced in the first hours of contacting mixture M1 with the activated carbon. The total capacity of the activated carbon at the break through point of DPGME was 23.2 g/kg GAC.

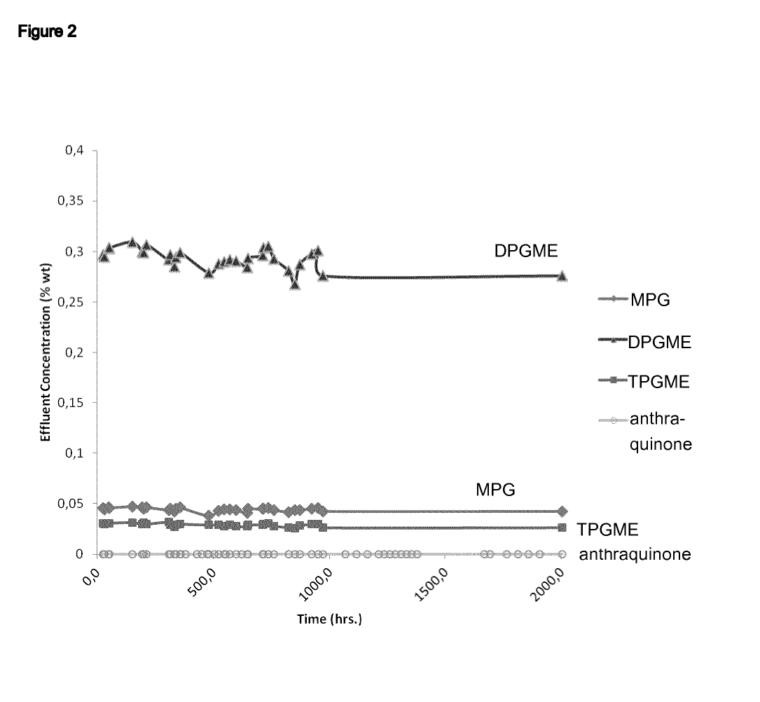

Following the first 30 hours, the contacting of the mixture M1 with the activated carbon was further continued. FIG. 2 shows the concentrations of the individual oxygenates in the mixture M2 following a continuous contacting for 2000 hours in total. No break-through for anthraquinone (indicated by circles) was observed within this time period. The TOC of mixture M2 observed after 2000 hours (i.e. with the exception of anthraquinone for which no break-through was observed) was 0.2 weight-% relative to the total weight of mixture M2.

### Example 2

### Reduction of TOC in Wastewater Using an Organic Polymer

Wastewater containing MPG, DPGME, TPGME and anthraquinone in the amounts indicated below in Table 2 representing a mixture M1 was obtained from a large scale propylene oxide production plant, following the downstream processing of a reaction mixture obtained by oxidizing propene with hydrogen peroxide to propylene oxide using a heterogeneous zeolitic catalyst comprising titanium silicalite-1.

TABLE 2

| Component | Amount in mixture M1 | |
|---|---|---|
| MPG | 0.04 | weight-% |
| DPGME | 0.15 | weight-% |
| TPGME | 0.02 | weight-% |
| Anthraquinone | 52 | weight-ppb |
| TOC | 0.13 | weight-% |
| Water | 99.66 | weight-% |

The concentrations of the oxygenates MPG, DPGME TPGME and anthraquinone and the TOC were determined for mixture M1 and further for mixture M2 obtained following a continuous contacting of mixture M1 with the organic polymer as described in Example 1.

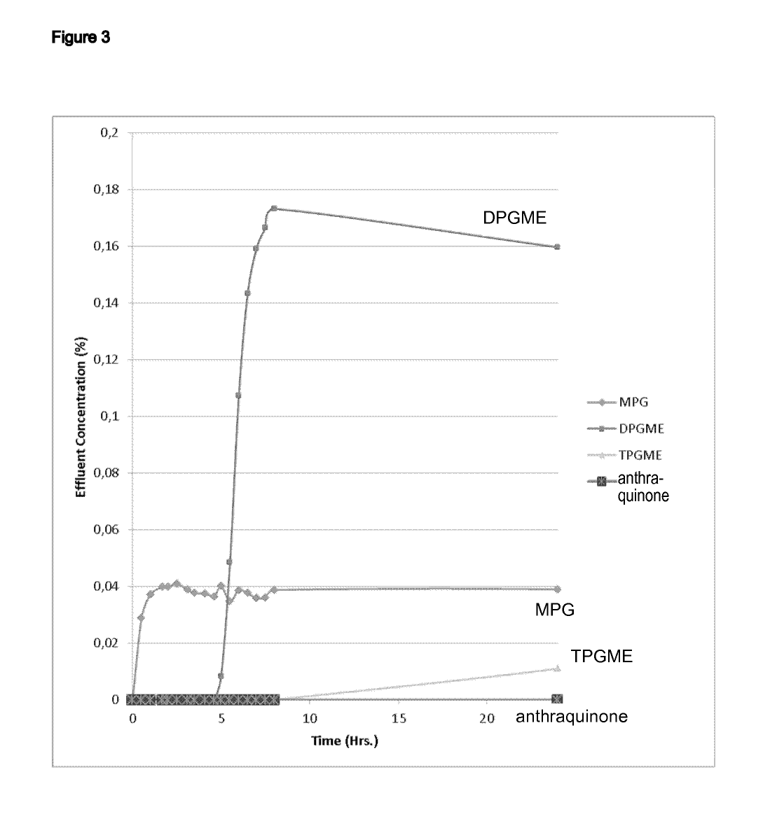

A chromatography column as described in Example 1 having a bed volume of 110.6 ml was packed with 30 g of a polystyrenic resin (Optipore L-483, Dowex). The resin was held in place by a 1 cm long portion of glass wool placed at the top and bottom of the tube, respectively. The mixture M1 was passed at ambient temperature over the resin with a bed volume of 4.6 h⁻¹, so that the contact time was 13 min. The contacting was performed and monitored for 1500 hours in total. FIG. 3 shows the MPG (diamonds), DPGME (squares), TPGME (triangles) and anthraquinone (squared asterisks) concentrations in the mixture M2 obtained following a continuous contacting of mixture M1 with the polystyrenic resin for the first 24 hours. MPG was not retained by the resin. A break-through for DPMGE and TPMGE was observed after about 5 and 8 hours, respectively. The TOC could be considerably reduced in the first hours of contacting mixture M1 with the polystyrenic resin.

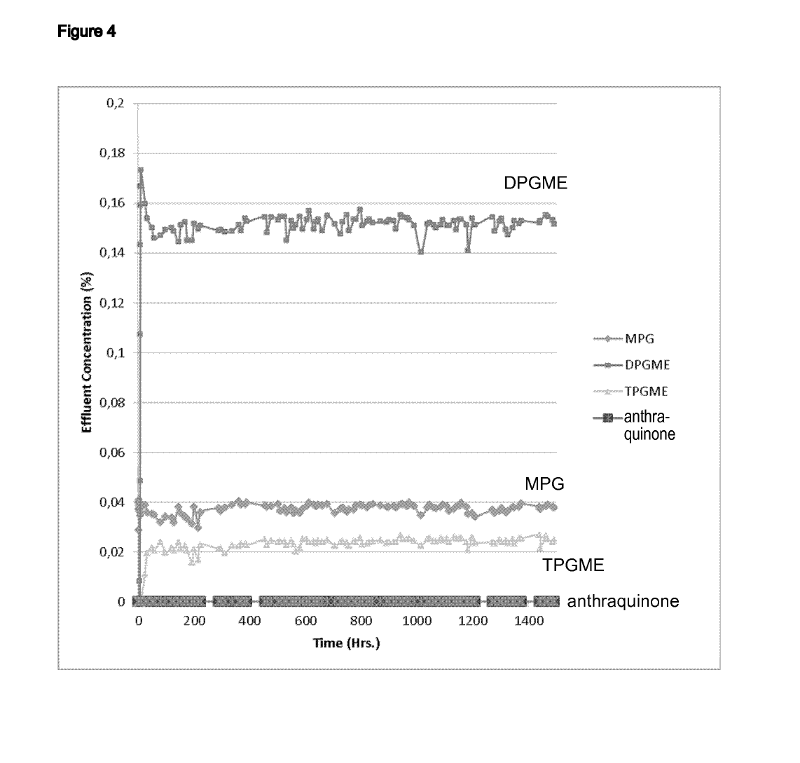

The contacting was further continued. FIG. 4 further shows the concentrations of the individual oxygenates in the mixture M2 following the contacting of mixture M1 with the polystyrenic resin over a time period of 1500 hours. No break-through for anthraquinone (indicated by squared asterisks) was observed within this time period. The TOC after 1500 h hours in mixture M2 (i.e. with the exception of anthraquinone for which no break-through was observed) was 0.13 weight-%, relative to the total weight of the mixture M2.

### Example 3

### Adsorbing Agent Replacing a Spent Reverse Osmosis Unit

A wastewater stream was obtained from a large scale propylene oxide production plant, following the downstream processing of a reaction mixture obtained by oxidizing propene with hydrogen peroxide to propylene oxide using a heterogeneous zeolitic catalyst comprising titanium silicalite-1. The wastewater stream had a similar composition as the wastewater according to Examples 1 and 2. The TOC of the wastewater was in the range of from 0.15 to 0.25 weight-%.

According to a first experimental setup, this wastewater stream was treated using a reverse osmosis membrane, and a treated wastewater stream was obtained as permeate having a TOC of 0.005 to 0.015 weight-%. During the reverse osmosis membrane treatment, the feed flowrate of the wastewater stream to be passed through the reverse osmosis membrane was 50 m³/h at a temperature of the feed stream of 30 to 35° C. and a pressure of the feed stream of 4 bar. As reverse osmosis membrane, Filmtech® BW30-XFR (DOW) was employed at a pressure of 35 bar and a temperature of 30 to 35° C. The flowrate of the permeate having a TOC of 0.01 weight-% was 47 m³/h, at a pressure of 1 bar and a temperature of 30 to 35° C.

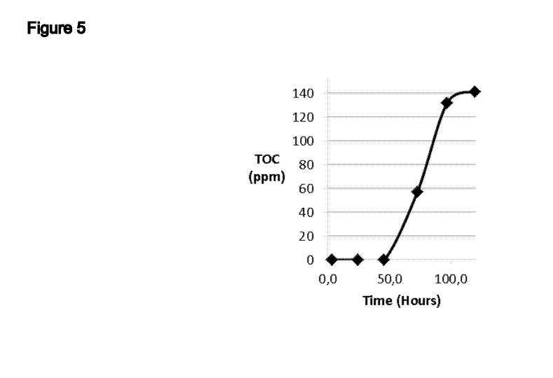

In a second experimental setup, the wastewater stream obtained from the large scale propylene oxide production plant and having a TOC of 0.2 weight-% was contacted with an adsorbing agent according to the present invention. As adsorbent, a carbon bed was used consisting of Carbsorb 40 (Calgon; granular activated carbon). The bed consisted of 68 g of Carbsorb 40, and the wastewaterstream was passed through the bed with a flow rate of 0.3 ml/min. The column diameter in which the bed was arranged was 1.6 cm, the column length was 62 cm. The length of the bed in the column was 55 cm, and the bed volume was 110.6 ml. The wastewater stream was passed at ambient temperature over the GAC with a bed volume of 0.16 h⁻¹. After 50 hours, the TOC of the treated wastewater stream leaving the bed was 0.001 weight-%; after 70 hours, the respective TOC was 0.005 weight-ppm, and 0.015 weight-% after 120 hours. In FIG. 5, the TOC of the treated wasterwater stream is shown as a function of the runtime of the treatment using the activated carbon bed.

The comparison of the two experimental setups shows that for a certain period of time (up to 120 hours), the treatment of the wastewater with an adsorbent according to the invention leads to the same results as a treatment with a reverse osmosis membrane—in both cases, the TOC of the obtained wastewater was at most 0.015 weight-%. Therefore, in particular in a large-scale industrial plant, the contacting of a wastewater stream with an adsorbing agent arranged upstream of a reverse osmosis treatment can be carried out as a bridging measure when a spent reverse osmosis unit is to be replaced with a fresh reverse osmosis unit.

### CITED LITERATURE

WO-A 2004/000773
US-A 5,599,955
US-A 2002/010378
US-A 6,288,287
US-A 5,269,933
EP-A 0 532 905
EP-A 0 324 915
US-A 6,712,882
Ullmann's Encyclopedia of Industrial Chemistry, 5th edition, volume A 13 (1989) pages 443-466

1. A process for reducing total organic carbon (TOC) in an aqueous mixture M1, the process comprising:
(a) contacting the mixture M1 which comprises at least one oxygenate comprising from 1 to 16 carbon atoms with an adsorbing agent, and adsorbing at least a portion of an oxygenate at the adsorbing agent;
(b) separating an aqueous mixture M2 from the adsorbing agent, the mixture M2 being depleted of the oxygenate adsorbed in (a); and
(c) separating an oxygenate from the mixture M2 obtained in (b) by subjecting the mixture M2 to reverse osmosis in at least one reverse osmosis unit comprising a reverse osmosis membrane to obtain an aqueous mixture M3 depleted of the oxygenate,
wherein the aqueous mixture M1 is obtained as waste water from preparation of an olefin oxide.

2. The process of claim 1, wherein the aqueous mixture M1 comprises
water in an amount of at least 95 weight-%, relative to a total weight of the aqueous mixture M1, and
the at least one oxygenate in an amount of at most 1 weight %, relative to the total weight of the aqueous mixture M1.

3. The process of claim 1, wherein the at least one oxygenate comprised in the mixture M1 is selected from the group consisting of an alcohol, an ether, an aldehyde, a ketone, and a combination of two or more thereof.

4. The process of claim 1, wherein the adsorbing agent in (a) is selected from the group consisting of activated carbon, an organic polymer, a silica gel, a molecular sieve, and a combination of two or more thereof.

5. The process of claim 1, wherein the adsorbing agent in (a) has a total pore volume in a range of from 0.1 to 3 cm³/g determined according to DIN 66133.

6. The process of claim 1, wherein the adsorbing agent in (a) has a mean pore size in a range of from 5 to 900 Angstrom determined according to DIN 66133.

7. The process of claim 1, wherein the adsorbing agent in (a) has a BET surface area in a range of from 500 to 1500 m²/g determined according to DIN 66131.

8. The process of claim 1, wherein the contacting (a) is performed in continuous mode, wherein the mixture M1 is passed over the adsorbing agent provided in a suitable container.

9. The process of claim 1, wherein the contacting in (a) is performed at a pressure in a range of from 0.7 to 20 bar, and at a temperature in a range of from 5 to 80° C.

10. The process of claim 1, wherein an oxygenate adsorbed in (b) is anthraquinone and/or an anthraquinone derivative.

11. The process of claim 1, wherein the reverse osmosis membrane in (c) is selected from the group consisting of a tubular membrane, a capillary membrane, a spiral membrane, a hollow fiber membrane, and a combination of two or more thereof.

12. The process of claim 1, wherein the reverse osmosis in (c) is performed in continuous mode.

13. The process of claim 1, wherein the subjecting in (c) is performed at a pressure in a range of from 2 to 100 bar and at a temperature in a range of from 5 to 80° C.

14. The process of claim 1, wherein a TOC of the mixture M3 obtained in (c) is at most 0.1% of the TOC of the mixture M1.

15. The process of claim 1, further comprising
(d) subjecting the mixture M3 obtained in (c) to a biological wastewater treatment, obtaining a mixture M4.

16. The process of claim 1, wherein the olefin oxide is obtained from an olefin, by epoxidation with hydrogen peroxide.

17. The process of claim 16, wherein the olefin oxide is propylene oxide and the olefin is propene.

18. The process of claim 1, wherein the olefin oxide propylene oxide obtained by a process comprising
(i) providing a mixture comprising an organic solvent, propene, and an epoxidation agent;
(ii) subjecting the mixture provided in (i) to epoxidation conditions in the presence of a catalyst, obtaining a mixture comprising the organic solvent, propylene oxide, water, and at least one oxygenate selected from the group consisting of an alcohol, an ether, an aldehyde, a ketone, and a combination of two or more thereof;
(iii) separating propene and propane from the mixture obtained from (ii) obtaining a mixture being depleted of propene and optionally propane, and comprising water, propylene oxide, the organic solvent, and the at least one oxygenate;
(iv) separating propylene oxide from the mixture obtained in (iii), obtaining a mixture being depleted of propylene oxide and comprising water, the organic solvent, and the at least one oxygenate;
(v) separating the organic solvent from the mixture obtained in (iv), obtaining a mixture being depleted of the organic solvent and comprising water, and the at least one oxygenate; and
(vi) subjecting the mixture obtained in (v) to a propylene glycol removal stage, comprising
(I) evaporating the mixture in at least two evaporation and/or distillation stages at decreasing operating pressures of the evaporators and/or distillation columns obtaining a mixture (M′) and a mixture (M″);
(II) separating the mixture (M′) obtained in (I) in at least one further distillation stage, obtaining a mixture (M-I) being enriched in water, and a mixture (M-II) being depleted of water; and
(III) separating propylene glycol from the mixture (M-II) in at least one further distillation stage obtaining a mixture being depleted of propylene glycol and comprising water and the at least one oxygenate;
wherein the mixture obtained from (vi)(III) is the aqueous mixture M1.

19. A purified wastewater, or obtained by the process of claim 15 as mixture M4, comprising one or more of anthraquinone and an anthraquinone derivative.

20. A method for replacing a reverse osmosis unit in a treatment of wastewater the method comprising:
using an adsorbing agent in a time slot in which a first, at least partially spent reverse osmosis unit downstream of said adsorbing agent is taken out of operation and a second, fresh reverse osmosis unit is taken into operation downstream of said adsorbing agent, replacing the first reverse osmosis unit,
wherein the wastewater is obtained from a process for preparing an olefin oxide.
